(19) United States
(12) Patent Application Publication
(10) Pub. No.: US 2003/0098399 A1
(43) Pub. Date: May 29, 2003

(54) Apparatus for supporting a model craft

(76) Inventor: Albert R. Rodriguez, Houston, TX (US)

Correspondence Address: D'AMBROSIO & ASSOCIATES, PLLC., Suite 930, 2925 BRIAR PARK DR., Houston, TX, 77042, US

(21) Appl. No.: 10/337,079

(22) Filed: Jan. 6, 2003

Related U.S. Application Data
(63) Continuation-in-part of application No. 09/881,612, filed on Jun. 13, 2001.

(51) Int. Cl. F16M 11/00

(52) U.S. Cl. 248/176.1

(57) ABSTRACT

The apparatus for supporting a model craft in multiple positions comprises a pedestal, a plurality of balls within sockets located on the pedestal, each ball securely rotatable within the socket. A plurality of support members are adapted to support the model craft. One support member is attached to each ball. A bumper is fixed to the end of the support member so that the model craft rests on the bumper. The pedestal provides a base support for the apparatus. The pedestal can comprise a flat base, a base tripod, or alternatively, a raised columnar base.

The ball/socket assembly is adapted to rotate the model craft in three planes, longitudinal plane, lateral plane and vertical plane to simulate pitch, yaw and roll of a craft.

### CROSS REFERENCES TO RELATED CASES

This is a continuation in part of U.S. patent application Ser. No. 09/881,612 filed Jun. 13, 2001, abandoned contemporaneously with the filing of this application.

### FIELD OF THE INVENTION

This invention relates to an apparatus for supporting a model aerospace craft in multiple positions.

### BACKGROUND OF INVENTION

The hobby of assembling and displaying model aircraft has grown and now includes the display of fighter planes, commercial aircraft, helicopters and space vehicles. Stands are used to mount and display the model air and space crafts. Typically the stands are static and do not allow for realistic positioning of the crafts. Stands to adjustably mount other objects, eye glasses, lamps or hats have been disclosed.

U.S. Pat. No. 791,682 to Fall discloses an adjustable display stand for hats. The '682 patent teaches a rack for holding hats or other articles on a vertically moveable mount. The Fall patent allows movement only along a vertical axis. Faase et al., U.S. Pat. No. 2,871,868, teaches an adjustable mount for an umbrella. The Faase patent discloses the use of a universal joint with tightening means allowing the umbrella limited movement in all directions.

Ford & Alexander, U.S. Pat. No. 560,092, disclose a support for the combination of a gas-pipe and a blowpipe. As described in the '092 patent, a vertically adjustable portion has a double ball and socket adjustment for limited movement in other axes. The patent also discloses having a clamp to hold the blowpipes.

U.S. Pat. No. 94,712 to Chinnock describes an improved toilet mirror. In the '712 patent, the base upon which the mirror is mounted is disclosed as being held in place by a friction force created by two spring-loaded plates. The Chinnock patent discloses that the toilet mirror is adjustable by means of springs in combination with a projecting arm and has a swivel motion on the post of a stand.

Campo discloses a general utility lamp in U.S. Pat. No. 2,618,451. The lamp has a base or support (the standard) and a housing that is swivelly connected to the standard. The '451 patent comprises a vertically adjustable post and a slidably engagable and swivelly supported arm. The arm is disclosed as being able to swing in the horizontal axis. The Campo patent discloses a ball 21 that is snapped into a socket for the swivel movement. Also disclosed is a pin positioned in the socket to control the swivel movement. The '451 patent also teaches the use of a swivelly mounted clamp. According to the Campo disclosure, the lamp has a limited ability to move in several directions.

Different types of attachment members have been used over the years in relation to support stands. U.S. Pat. No. 2,948,500 was given to Kuhn for a device for carrying articles on display. The '500 patent teaches an apparatus for holding eyeglasses on display. The device comprises a base, an elongated support member, a single strip-shaped attachment member, and a ball and joint for connecting the attaching member to the supporting member. The supporting member has the attachment means for holding eyeglasses.

Meinel was granted U.S. Pat. No. 5,769,369 for a mobile office stand used to support a portable computer or electronic organizer in vehicles. The '369 patent discloses an ergonomically designed workstand for electronic devices. The apparatus includes a generally rectangular shaped cradle for retaining the device. The computer stand has at least one pair of opposed jaw members attached by tensioned springs. The base on the stand comprises a universal ball and socket, swivel, or other ratchet joint to attach the base to the cradle.

Aerospace craft are dynamic vehicles. Owners of the model crafts often wish to mount and display model vehicles on a realistic, non-static stand. A need exists for a model craft or vehicle stand that allows model crafts or vehicles of different types of materials and weights to be displayed in a variety of realistic positions. In addition, most stands require that the model be modified in some manner. These modifications can involve drilling or cutting the model for interfacing with the stand. A need exists for a model craft or vehicle stand that requires no modifications to the model so that the integrity and structure remains untouched.

### SUMMARY OF THE INVENTION

The present invention relates to an apparatus for supporting and displaying a model craft of different types of materials and weights in multiple positions. Model crafts or vehicles, such as boats, cars, planes, helicopters, spacecrafts, rocket launchers and rocket ships, are presently held upright by static model stands or hung from their wings or other attachments. Hobbyist and collectors of models desire authentic model crafts that are capable of being placed in simulated motion along three axes, pitch, yaw and roll. The present invention comprises a novel apparatus that allows support and realistic display of the model crafts along the three axes simultaneously without requiring any modifications to the model for use thereby preserving the completeness and detail of the model replica. Preferably, the apparatus of this invention can be scaled to support different size and shape model crafts.

In one preferred illustration, the apparatus for supporting a model craft in multiple positions comprises a pedestal, a plurality of balls within a plurality of sockets, each within its own socket. The sockets are located on the pedestal and each ball is rotatable within its socket. Preferably, a plurality of support members are attached to the balls so that one support member is attached to one ball. The pedestal provides a base support for the apparatus. In one embodiment, the pedestal is comprised of a flat base and a plate mounted on the pedestal for securing the balls within the sockets. The plate is secured to the pedestal with a plate attachment means selected from screws, nuts and bolts, glue and combinations thereof. Alternatively, the pedestal can comprise a tripod or a raised columnar base where the balls and sockets are located on the upper surface of the raised columnar base.

In one preferred embodiment, the apparatus comprises at least three balls within at least three sockets. Preferably, each ball within its socket is securely rotatable up to 160°, so that the support members attached to the balls are adapted to rotate the model craft in three planes. Each ball is connected to its support member with a support member attachment means. The support member attachment mean can be selected from tape, glue, hook and loop attachments and combinations thereof. In one preferred embodiment, each ball is rotated within each socket so that collectively the support members can position the model craft along a lateral axis, a longitudinal axis and a vertical axis.

Preferably, the support members comprise a first end and a second end where the first end is attached to a ball and the second end is attached to a bumper. In this embodiment, the model craft rests upon and is supported by the bumpers. In this way, each support member rotates independently and the bumpers support the model craft. Preferably, each support member is secured to the bumper with a bumper attachment means selected from tape, glue, hook and loop attachments and combinations thereof. In one preferred apparatus, the support members are manufactured from a material selected from plexiglas, plastic, elastomeric material, wood, glass, metal or combinations thereof.

In another embodiment, the apparatus for supporting a model craft in multiple positions comprises a pedestal comprising a flat base, a plurality of balls and a plurality of sockets located on the pedestal with each ball within one socket securely rotatable within the socket so that the attached support member is adapted to position the model craft along a lateral axis, a longitudinal axis and a vertical axis. In one preferred embodiment, a plate is mounted on the pedestal for securing the balls within each socket. A plurality of support members are attached to the balls so that one support member is attached to each ball. Preferentially, the support members comprise a first end attached to one ball and a second end. A bumper on the second end of each support member is adapted to support the model craft. Each ball is connected to the support members with a support member attachment means selected from tape, glue, hook and loop attachments and combinations thereof.

In an alternative embodiment, the apparatus supports a model aerospace craft in multiple positions. This apparatus comprises a pedestal, a plurality of balls and a plurality of sockets located within the pedestal with each ball within one socket where each ball is securely rotatable within the socket so as to position the model aerospace craft along a pitch axis, a roll axis and a yaw axis. The apparatus also comprises a plurality of support members attached to the balls so that one support member is attached to one ball. Preferably, the support members comprise a first end attached to one ball and a second end attached to a bumper where the bumper is adapted to support the model aerospace craft along the three planes.

### BRIEF DESCRIPTION OF THE DRAWINGS

FIG. 1 depicts a three dimensional view of one embodiment of the present invention.

FIG. 2 is a cross-sectional view of one embodiment of the invention illustrating the ball and sockets secured in the pedestal by a single cover plate.

FIG. 3 is a cross-sectional view of one embodiment of the invention illustrating the single cover plates for securing the ball and sockets to the pedestal base.

FIG. 3a is a cross-sectional view of one embodiment of the invention illustrating the ball secured within the socket.

FIG. 4 is a cross-sectional view of one embodiment of the invention illustrating the pedestal having a raised columnar base.

FIG. 5 is a cross-sectional view of one embodiment of the invention illustrating the pedestal base as a tripod.

FIG. 6 depicts a three dimensional view of an aircraft showing the three axes of movement attached to the apparatus.

It is noted that the drawings illustrate only some typical embodiments of the invention and are therefore not to be considered limiting of its scope, for the invention will admit to other equally effective embodiments.

### DETAILED DESCRIPTION OF THE INVENTION

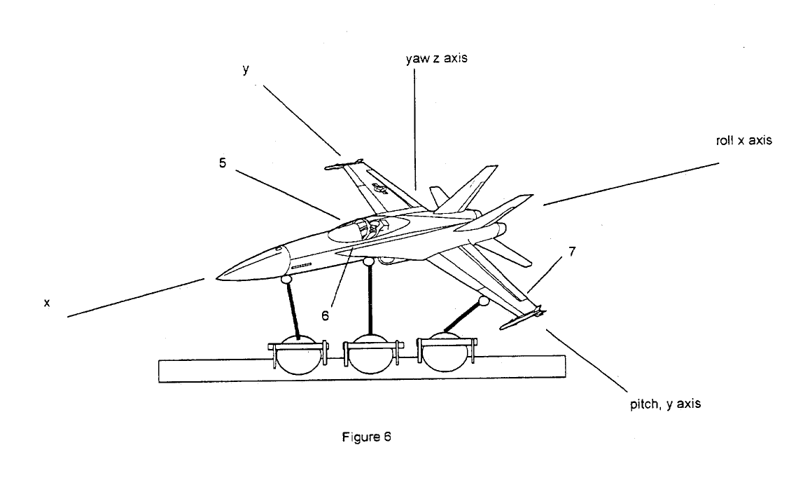

The apparatus of this invention supports and displays model crafts in multiple positions. The collection and display of model crafts or vehicles, including planes, jets, helicopters, and spacecraft such as rocket launchers and rocket ships, is a popular hobby. Authenticity is important to collectors of models. Real aircraft are capable of motion along three axes, pitch, yaw and roll as illustrated in FIG. 6. The apparatus for supporting a model craft of the present invention allows a user to simultaneous display the pitch, yaw and roll positioning of model crafts. Preferably, the apparatus can be sized to hold many different size and shape model crafts. The material comprising the model craft 5 is a factor in the size and shape and material comprising the apparatus of this invention 10. Plastic and wooden crafts 5 are lighter in weight and can be supported by plastic or wooden apparatuses 10. Die cast models 5 are made of metals and require an apparatus 10 that can support the heavier weight, metal or strong plastic, for example.

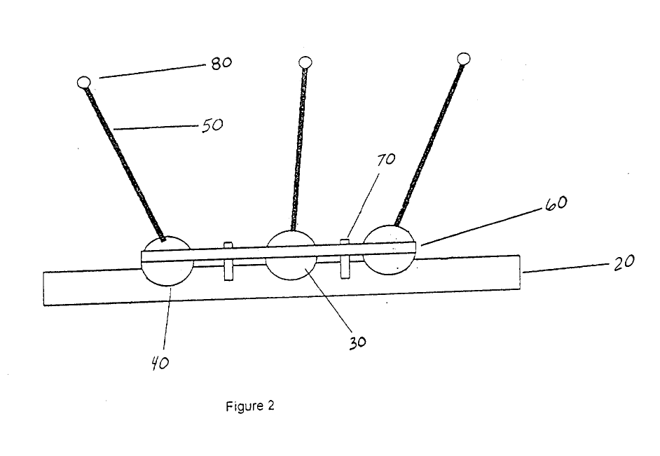

Referring to FIG. 6, the model craft 5 comprises a body or fuselage 6. In one preferred embodiment, the apparatus supports and displays the model craft by upholding either the fuselage 6 or the fuselage 6 and wings 7. Multiple positions are possible with the support members in various locations of the craft. FIG. 2 illustrates one preferred apparatus 10 for supporting a model craft in multiple positions. This preferred apparatus for supporting a model craft in multiple positions comprises a pedestal 20, a plurality of balls 30 with a plurality of sockets 40 located on the pedestal 20 and a plurality of support members 50 attached to the balls 30 so that one support member 50 is attached to one ball 30. The pedestal comprises a plurality of sockets and each socket comprises a ball rotatable with it.

Another embodiment of the apparatus has a pedestal comprised of a flat base 20 to provide stable support for the apparatus. A plate 60 is mounted on the pedestal 20 for securing the balls 30 within the sockets 40. The plate has an opening slightly smaller than the widest diameter of the balls so that when the plate is secured to the pedestal, the balls are free to rotate but cannot come out of the socket. In an alternative, embodiment, the sockets are shaped to hold the balls within them so that they are rotatable as well as secured. The plate 60 is secured to the pedestal 20 with a plate attachment means 70 selected from screws, nuts and bolts, glue and combinations thereof.

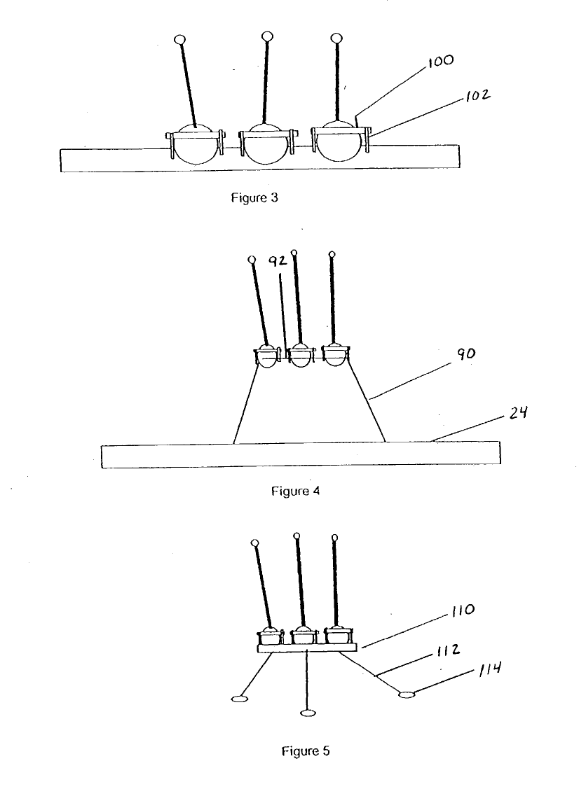

In one alternate embodiment, as depicted in FIG. 3, each ball 30 within each socket 40 is secured within the socket by its own cover plate 100. Each cover plate 100 is secured to the pedestal by a cover attachment means 102, such as screws, nuts and bolts, glue and combinations thereof. In an alternate embodiment, as depicted in FIG. 3a, each ball 30 within each socket is secured within the socket by forcing or snapping the ball 30 into each socket 42 that is slightly small in diameter than the ball 30. Each socket 42 is shaped to securely hold the ball 30 within it

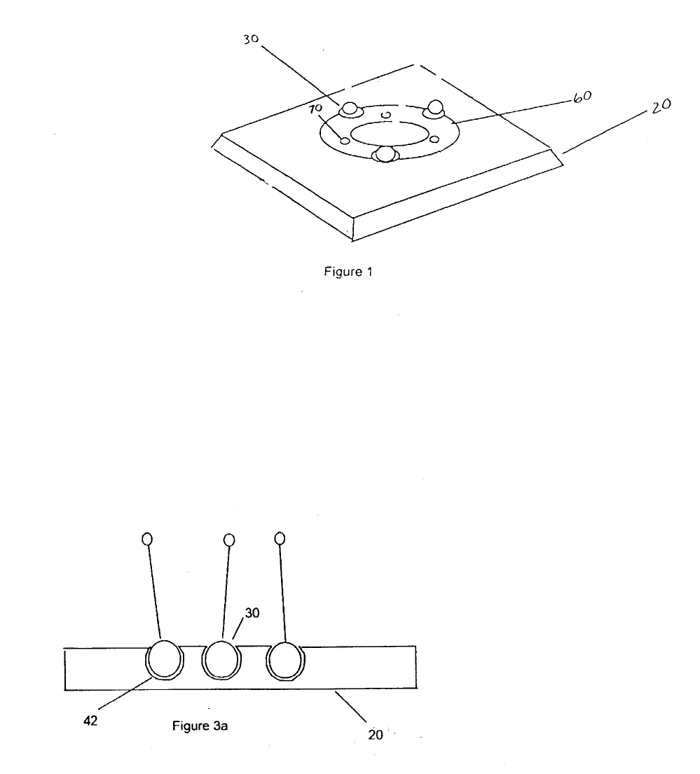

The pedestal 20 supports and provides stability for the apparatus 10 upon a surface such as a table or desk. In one embodiment, the pedestal 20 comprises a base 22 as shown in FIG. 1. The base 22 can have various shapes, triangular, rectangular, octagonal etc., depending on aesthetic preferences. The pedestal 20 can also comprise different sizes of height, width and length. The size and shape of the pedestal 20 can vary as long as the pedestal 20 ultimately supports the weight and size of the model craft. As such, the size and shape of this apparatus are adapted to accommodate the weight and size of the model craft and varieties in shapes and sizes are within the scope of this invention.

Referrring to FIG. 4, the pedestal comprises a raised columnar base 90. In this embodiment, the balls 30 and sockets 40 are located on the upper surface of the raised columnar base 90. Preferably, the raised columnar base is attached to a support platform 24. As illustrated in FIGS. 2, 4 and 5, preferred embodiments of the apparatus 10 comprise various shapes. FIGS. 1 and 2 depict flat based pedestals. Alternatively in FIG. 5, the pedestal is tripod 110. The tripod 10 can be adjustable so that the height of the apparatus 10 is variable. The apparatus 10 is raised above the tripod 110 and supported by at least 3 tripod legs 112. The tripod legs 112 are attached to a tripod foot 114 and the pedestal 20 by a tripod attachment means selected from screws, nuts and bolts, glue and combination thereof.

Referring to FIGS. 1 and 2, the apparatus 10 comprises at least three balls 30 within at least three sockets 40. Preferably, each support member comprises a first end 52 and a second end 54. The first end 52 is attached to a ball 30 and the second end 54 is attached to a bumper 80. The support members 50 can be manufactured from a material selected from plexiglas, plastic, elastomeric material, wood, glass, metal or combinations thereof. The bumpers 80 support the model craft and are designed to prevent scratching of the model craft. The material comprising the bumper 80 can be selected from rubber, plastic, metal, glass, etc., as such materials are known in the art. The means of attachment depends on the type of material comprising the various components of the apparatus 10. The bumper attachment means can be selected from tape, glue, hook and loop attachments and combinations thereof.

Illustrated by FIGS. 2 and 6, each ball 30 within its socket 40 is rotatable along three planes, so that the support members 50 attached to the balls 30 are adapted to rotate the model craft in three planes. As seen in FIG. 2, each ball 30 is rotatable up to 160° or even higher—if necessary to the hobbyist—within each socket 40 so that the attached support member 50 is adapted to position the model craft along a lateral axis, a longitudinal axis and a vertical axis. Preferably, the ball 30 is connected to its support member 50 by a support member attachment means selected from tape, glue, hook and loop attachments and combinations thereof.

FIG. 1 depicts one embodiment of the apparatus 10 for supporting a model craft in multiple positions having a pedestal with a flat base 22, at least three balls 30 within three sockets 40 located on the pedestal 20 with each ball 30 within one socket 40 and each ball rotatable within its socket along three planes. Preferably, the plate 60 is mounted on the pedestal by a plate attachment means 70 selected from screws, nuts and bolts, glue and combinations thereof for securing each ball within its socket. The balls 30 are connected to each support member 50 by a support member attachment means selected from tape, glue, hook and loop attachments and combinations thereof. At least three support members 50 are attached to the balls 30 so that one support member 50 is attached to one ball 30 and each support member comprises a first end 52 attached to a ball 30 and a second end 54 attached to a bumper 80. The size and shape of the support members 50 can vary according to the aesthetic preference of the user. The variance is limited to a size and shape required to support the model craft 5. The bumper 80 is adapted to support and cushion the model craft.

FIG. 4 depicts another embodiment of the pedestal 20. The pedestal 20 comprises a raised columnar base 90 where the ball 30 and socket 40 assemblies are located on the upper surface 92 of the raised columnar base 90 above the columnar base 24. Each ball 30 on the raised columnar base 90 is rotatable within each socket 40 so as to position the model craft along a lateral axis, a longitudinal axis and a vertical axis. The support members 50 are attached to the balls 30 where one support member 50 is attached to one ball 30. The support members 50 comprise a first end 52 attached to one ball and a second end 54 attached to a bumper 80 adapted to support of the model craft. The length of the support member can vary according to the model craft and wishes of the user.

In one preferred embodiment, the apparatus 10 supports a model aerospace craft in multiple positions comprising a pedestal 20, a plurality of balls 30 and a plurality of sockets 40 located within the pedestal 20 with each ball 30 within one socket 40 where each ball 30 is securely rotatable within the socket 40 so as to position the model aerospace craft along a pitch axis, a roll axis and a yaw axis. The apparatus 10 also comprises a plurality of support members 50 attached to the balls 30 so that one support member 50 is attached to one ball 30. The support member 50 comprises a first end 52 attached to one ball 30 and a second end 54 attached to a bumper 80 where the bumper 80 is adapted to support the model aerospace craft.

As seen in FIGS. 2 and 6, the ball 30 within the socket 40 provides the rotational movement for the apparatus 10 of this invention so that a model craft or vehicle 5 can be positioned along the pitch, yaw and roll axis. One preferred embodiment comprises a ball 30 that rotates within the socket 40 so as to position the model craft 5 along the lateral, longitudinal, and vertical axes, y, x and z. In another embodiment, the ball 30 can rotate the support member 50 up to 360° along the yaw axis, z. The ball 30 swivels within the socket 40. Other swivel joints are known in the art and within the scope of this invention. The socket 40 can be integral with the pedestal, or alternatively, the socket can be a separate component and attached to the pedestal 40 as in FIG. 2. Each ball's 30 rotation within each socket is limited by the edges of the socket 40 encompassing the ball 30, the higher the edges of the socket, the greater the limitation of the rotation of the ball and its attachment. Preferably, the ball 30 with its attachment can rotate up to 160° or higher within the socket 40 so as to position the model craft 5 along a lateral axis, a longitudinal axis and a vertical axis. In this way, the model craft 5 can be positioned along a pitch axis, a roll axis and a yaw axis.

The apparatus for supporting a model craft in multiple positions can be pre-assembled and sold in a kit so that model hobbyists can personally assemble it. In this embodiment, the apparatus comprises unassembled components. The unassembled components comprise a pedestal 20, a plurality of balls 30 with a plurality of sockets 40, a plate 60, and a plurality of support members 50 and bumpers 80. The components further include plate attachment means 70 selected from screws, nuts and bolts, glue and combinations thereof. The support member 50 components are attached to the bumpers 80 and balls 30 through an attachment means selected from tape, glue, hook and loop attachments and combinations thereof. The unassembled components can be contained within a kit.

The foregoing description is illustrative and explanatory of preferred embodiments of the invention and variations in the size, shape, materials and other details will become apparent to those skilled in the art. It is intended that all such variations and modifications which fall within the scope and spirit of the appended claims be embraced thereby.

1. An apparatus for supporting a model craft in multiple positions, the apparatus comprising:
a pedestal;
a plurality of sockets located on the pedestal, each socket comprising a ball securely rotatable within the socket; and
a plurality of support members attached to the balls so that one support member is attached to one ball.

2. The apparatus of claim 1 wherein the pedestal comprises a flat base.

3. The apparatus of claim 1 wherein the pedestal comprises a raised columnar base with the ball and sockets located on the upper surface of the raised columnar base.

4. The apparatus of claim 1 wherein the pedestal comprises a tripod.

5. The apparatus of claim 1, further comprising a plate mounted on the pedestal for securing the balls within the sockets.

6. The apparatus of claim 5 wherein the plate is secured to the pedestal with a plate attachment means.

7. The apparatus of claim 1 wherein each socket is shaped to securely hold the ball within it.

8. The apparatus of claim 6 wherein the plate attachment means is selected from screws, nuts and bolts, glue and combinations thereof.

9. The apparatus of claim 1 wherein the support members are manufactured from a material selected from plexiglas, plastic, elastomeric material, wood, glass, metal or combinations thereof.

10. The apparatus of claim 1 the plurality of sockets comprises at least three balls within sockets.

11. The apparatus of claim 1, wherein each support member comprises a first end and a second end, the first end attached to the ball and the second end attached to a bumper, the bumper adapted to support the model craft.

12. The apparatus of claim 11 wherein each support member is secured to the bumper with a bumper attachment means.

13. The apparatus of claim 12 wherein the bumper attachment means is selected from tape, glue, hook and loop attachments and combinations thereof.

14. The apparatus of claim 1 wherein each ball within each socket is secured by a single cover plate secured by a cover attachment means.

15. The apparatus of claim 14 wherein the cover attachment means is selected from screws, nuts and bolts, glue and combinations thereof.

16. The apparatus of claim 1 wherein each ball within its socket is rotatable along three planes, so that the support members attached to the balls are adapted to rotate the model craft in three planes.

17. The apparatus of claim 1 wherein each ball is connected to its support member with a support member attachment means.

18. The apparatus of claim 17 wherein the support member attachment means is selected from tape, glue, hook and loop attachments and combinations thereof.

19. The apparatus of claim 1 wherein the ball is rotatable up to 160° within the socket so that the attached support member is adapted to position the model craft along a lateral axis, a longitudinal axis and a vertical axis.

20. An apparatus for supporting a model craft in multiple positions, the apparatus comprising:
a pedestal, the pedestal having a flat base;
at least three balls within three sockets located on the pedestal, each ball within one socket, each ball rotatable within its socket along three planes;
a plate mounted on the pedestal for securing the balls within the sockets, the plate secured to the pedestal by a plate attachment means;
a support member attached to each ball, each support member comprising a first end attached to its ball and a second end; and
a bumper attached to the second end of each support member, the bumper adapted to support the model craft.

21. The apparatus of claim 20 wherein the ball is connected to its support member with a support member attachment means, the support member attachment means selected from tape, glue, hook and loop attachments and combinations thereof.

22. The apparatus of claim 20 wherein the ball is rotatable up to 160° within the socket so as to position the model craft along a lateral axis, a longitudinal axis and a vertical axis.

23. The apparatus of claim 20 wherein each support member is secured to the bumper with a bumper attachment means, the bumper attachment means selected from tape, glue, hook and loop attachments and combinations thereof.

24. An apparatus for supporting a model craft in multiple positions, the apparatus comprising:
a pedestal comprising a flat base;
a plurality of balls and a plurality of sockets located on the pedestal, each ball within one socket, the ball within its socket rotatable up to 160° within the socket so that the attached support member is adapted to position the model craft along a lateral axis, a longitudinal axis and a vertical axis;
a plurality of support members attached to the balls so that one support member is attached to one ball, the support member comprises a first end attached to one ball and a second end; and
a bumper attached to the second end of each support member, the bumper adapted to support of the model craft.

25. An apparatus for supporting a model aerospace craft in multiple positions, the apparatus comprising:
a pedestal;
a plurality of balls and a plurality of sockets located within the pedestal, each ball within one socket, each ball securely rotatable within the socket so as to position the model aerospace craft along a pitch axis, a roll axis and a yaw axis;
a plurality of support members attached to the balls so that one support member is attached to one ball, the support member comprises a first end attached to one ball and a second end; and
a bumper attached to the second end of each support member, the bumper adapted to support the model aerospace craft.

26. An apparatus for supporting a model craft in multiple positions, the apparatus comprising:
a pedestal, the pedestal comprising a raised columnar base;
a plurality of balls securely rotatable within a plurality of sockets located on the upper surface of the raised columnar base above the columnar base, each ball within one socket, the ball is rotatable within the socket so as to position the model craft along a lateral axis, a longitudinal axis and a vertical axis;
a plurality of support members attached to the balls so that one support member is attached to one ball, the support member comprising a first end attached to one ball and a second end; and
a bumper attached to the second end of each support member, the bumper adapted to support of the model craft.

27. An apparatus for supporting a model craft in multiple positions, the apparatus comprising:
a pedestal, the pedestal comprising a tripod;
a plurality of balls securely rotatable within a plurality of sockets located within the pedestal, each ball within one socket, the ball is rotatable within the socket so as to position the model craft along a lateral axis, a longitudinal axis and a vertical axis;
a plurality of support members attached to the balls so that one support member is attached to one ball, the support member comprises a first end attached to one ball and a second end; and
a bumper attached to the second end of each support member, the bumper adapted to support of the model craft.

28. A kit for an apparatus for supporting a model craft in multiple positions, the kit comprising:
a pedestal;
a plurality of sockets for position on the pedestal, each socket comprising a ball securely rotatable within the socket; and
a plurality of support members for attaching to the balls.
